(19) United States
(12) Patent Application Publication
(10) Pub. No.: US 2005/0035927 A1
(43) Pub. Date: Feb. 17, 2005

(54) Solid state imaging device, driving method therefor, and imaging apparatus

(75) Inventor: Masao Kimura, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/911,547

(22) Filed: Aug. 5, 2004

(30) Foreign Application Priority Data
Aug. 12, 2003 (JP) P2003-291942

(51) Int. Cl. G09G 3/20

(52) U.S. Cl. 345/55

(57) ABSTRACT

A solid-state imaging device includes sensor areas, in each of the sensor areas, a plurality of pixel sensors are disposed in the vertical direction and in the horizontal direction. Two vertical transfer portions are formed across each pixel column including the plurality of pixel sensors in the vertical direction. A controller controls electric charges stored in the pixel sensors vertically adjacent to each other in each pixel column to be simultaneously read in different directions by the two vertical transfer portions, and also controls each of the two vertical transfer portions to add and transfer electric charges for the plurality of pixel sensors. With this configuration, the time required for a vertical transfer operation can be decreased, and the frame rate of the solid-state imaging device can be improved.

### BACKGROUND OF THE INVENTION

1. Field of the Invention

The present invention relates to a progressive-scan-system solid-state imaging device and a driving method therefor for simultaneously reading electric charges stored in a plurality of pixel sensors that are disposed in a matrix in the horizontal and vertical directions. The present invention also relates to an imaging apparatus, for example, a digital still camera or a digital video camera, including an optical system, such as a lens, an image signal processor, and a recording medium. In the imaging apparatus, an image is read by using the solid-state imaging device through the optical system, undergoes predetermined signal processing, and is then recorded on the recording medium.

2. Description of the Related Art

Due to the versatility of functions of solid-state imaging devices, it is demanded that solid-state imaging devices used for digital still cameras achieve a multi-pixel output and a high frame rate, and also handle moving pictures. For moving pictures, if a decimation function is merely added to a multi-pixel solid-state imaging device, aliasing noise and aliasing signals are increased, and the image quality is seriously deteriorated. In contrast, according to a technique for reducing the number of pixels by adding pixel signals, the image quality is deteriorated less than that resulting from the decimation processing so that a high frame rate can be obtained (for example, see Japanese Unexamined Patent Application Publication No. 2000-115643).

In the progressive scan system used for digital still cameras as an electric-charge transfer method, electric charges of all pixels are read simultaneously so as to obtain signals without a time difference (for example, see Japanese Unexamined Patent Application Publication Nos. 9-129861 and 7-59012).

In the progressive scan system, however, for adding signals in the vertical direction, pixel signals having different color components are read continuously in the vertical direction. That is, in this method, signals having different color components are added. Accordingly, odd-numbered lines and even-numbered lines should be read with a time difference. For example, odd-numbered lines are first read, and then, after vertically transferring electric charge for a few lines for signal addition, even-numbered lines are read, and then, vertical transfer is similarly performed.

In this case, however, after reading odd-numbered lines, if the quantity of incident light considerably changes before reading even-numbered lines, such a change is reflected in a resulting image, and thus, advantages of the progressive scan system cannot be sufficiently exhibited.

### SUMMARY OF THE INVENTION

The present invention has been made in order to solve the above-described problems.

The present invention provides a solid-state imaging device including: sensor areas, in each of the sensor areas, a plurality of pixel sensors are disposed in the vertical direction and in the horizontal direction; two vertical transfer portions formed across each pixel column including the plurality of pixel sensors in the vertical direction; and a controller for controlling electric charges stored in the pixel sensors vertically adjacent to each other in each pixel column to be simultaneously read in different directions by the two vertical transfer portions, and also for controlling each of the two vertical transfer portions to add and transfer electric charges for the plurality of pixel sensors.

With this configuration, since two vertical transfer portions are provided for each pixel column, electric charges stored in adjacent pixel sensors in each pixel column can be simultaneously read in different directions. That is, even if adjacent pixel sensors have different color components, they can be simultaneously read to the different vertical transfer portions according to the color, and the signals representing the same color can be added and transferred.

According to the progressive-scan-system solid-state imaging device of the present invention, electric charges for a plurality of pixels in the vertical direction can be added without a time difference. Thus, in the progressive scan system, high-definition images can be obtained without a time difference. Additionally, the time required for a vertical transfer operation can be decreased, and the frame rate of the solid-state imaging device can be improved.

### BRIEF DESCRIPTION OF THE DRAWINGS

FIG. 1 is a schematic diagram illustrating a solid-state imaging device according to an embodiment of the present invention;

FIG. 2 is a schematic diagram illustrating another configuration of the solid-state imaging device of the present invention;

FIG. 3 is a schematic diagram illustrating a specific pixel structure;

FIG. 4 is a potential diagram illustrating a normal imaging operation by the solid-state imaging device; and

FIG. 5 is a potential diagram illustrating an operation for vertically adding electric charges by the solid-state imaging device.

### DESCRIPTION OF THE PREFERRED EMBODIMENTS

The present invention is described in detail below with reference to the accompanying drawings through illustration of an embodiment.

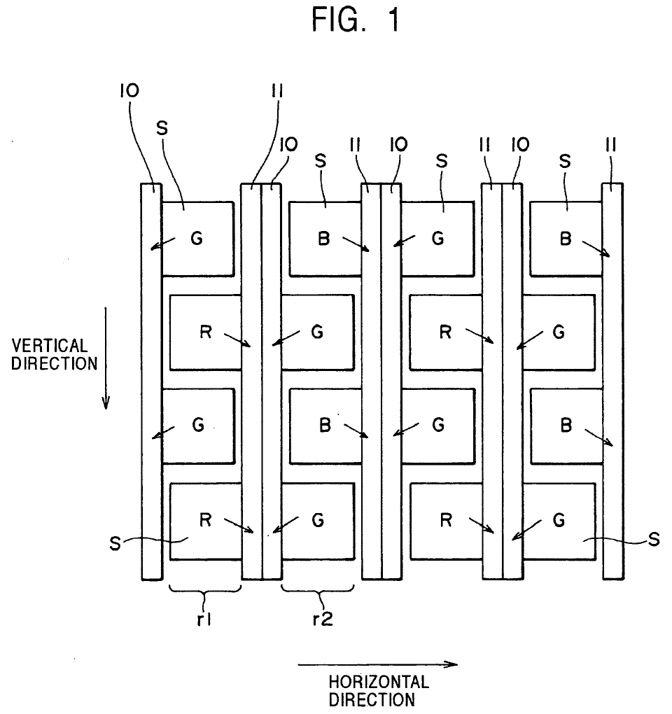

A solid-state imaging device constructed in accordance with an embodiment of the present invention shown in FIG. 1 includes sensor areas in which a plurality of pixel sensors S are disposed in the horizontal and vertical directions, and two vertical transfer portions 10 and 11 disposed at the two sides of each pixel column, which is formed of the plurality vertical pixel sensors S.

With this configuration, the reading and transferring of electric charges stored in the pixel sensors S is controlled by a controller (not shown). In this embodiment, electric charges stored in adjacent pixel sensors S in the vertical direction in each pixel column are read in different directions by the two vertical transfer portions 10 and 11. Then, electric charges read from the plurality of pixel sensors S are added and transferred in each of the vertical transfer portions 10 and 11.

In the solid-state imaging device shown in FIG. 1, the same color filters are disposed for every other pixel sensor of the sensor areas in each pixel column in the vertical direction. That is, in a pixel column r1, green (G), red (R), green (G), and red (R) filters are sequentially disposed, and in a pixel column r2, blue (B), green (G), blue (B), and green (G) filters are sequentially disposed. In the subsequent pixel columns, color filters are similarly disposed.

In the pixel sensors S arranged as described above, electric charges stored in the pixel sensors S corresponding to G are read to the vertical transfer portion 10 at the left side of the sensors S, while electric charges stored in the pixel sensors S corresponding to R and B are read to the vertical transfer portion 11 at the right side of the sensors S. That is, since the pixel sensors corresponding to the two colors are disposed alternately in each pixel column, the electric charges stored in the pixel sensors S of one color are read to the vertical transfer portion 10, while the electric charges stored in the pixel sensors S of the other color are read to the vertical transfer portion 11. Accordingly, the vertical transfer portion 10 or 11 can transfer electric charges only corresponding to the same color component of the pixel sensors S. Thus, even if electric charges stored in all the pixel sensors S are simultaneously read to the vertical transfer portions 10 and 11, they can be transferred without causing a mixture of the electric charges of the different colors.

Since electric charges having the same color component are read to the vertical transfer portion 10 or 11, the electric charges stored in the plurality of pixel sensors S corresponding to the same color in each pixel column can be added in the vertical transfer portion 10 or 11 by controlling the transfer timing.

With this configuration, according to the progressive-scan-system solid-state imaging device of this embodiment, electric charges stored in a plurality of pixel sensors S can be added in and output from the vertical transfer portions 10 and 11 simultaneously. That is, the electric charges stored in all the pixel sensors S can be read simultaneously, and the same color signals can be added in each vertical transfer portion 10 or 11 without a time difference.

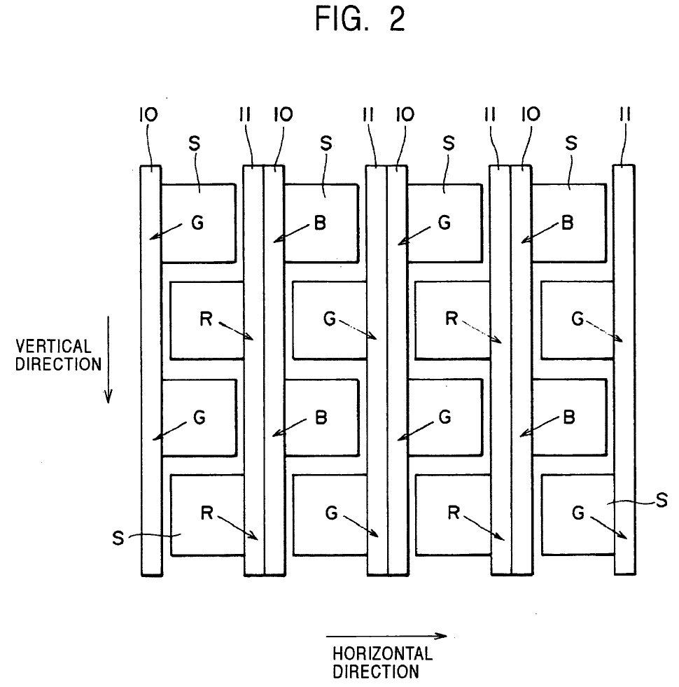

FIG. 2 is a schematic diagram illustrating another configuration of the solid-state imaging device. As in the imaging device shown in FIG. 1, in this device, two vertical transfer portions 10 and 11 are provided at the two sides of each pixel column formed of pixel sensors S. However, in the imaging device shown in FIG. 2, the reading directions of electric charges are different from those of the imaging device shown in FIG. 1.

More specifically, in this configuration, the reading directions are determined by the position of the pixel sensors S. For example, electric charges stored in the pixel sensors S at the first row are read to the vertical transfer portions 10 at the left side, while electric charges stored in the pixel sensors S at the second row are read to the vertical transfer portions 11 at the right side. The reading directions can be changed by varying the configuration of the channel stop regions or the electrodes between the pixel sensors S.

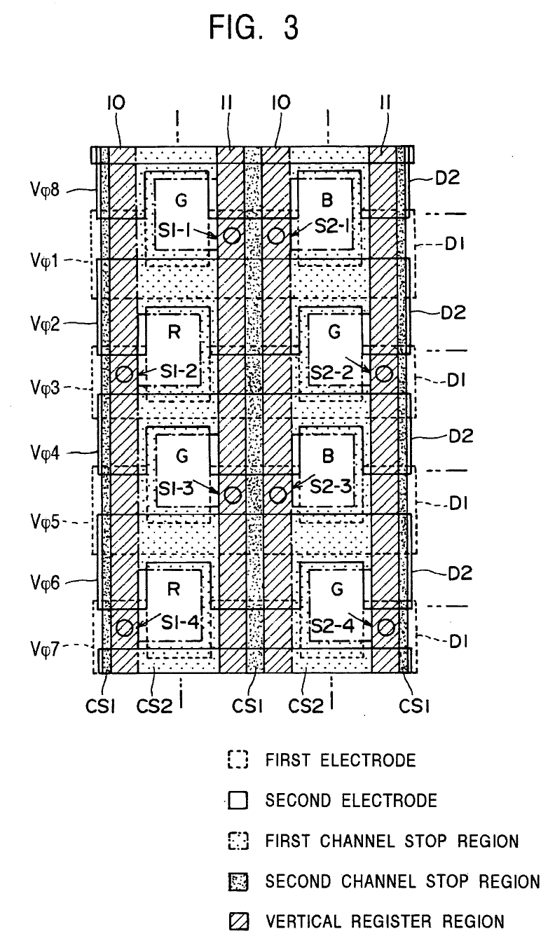

FIG. 3 is a schematic diagram illustrating a specific pixel structure when electric charges are read in the directions shown in FIG. 1. In this pixel structure, the vertical transfer portions 10 and 11 are disposed across the pixel sensors S, and more specifically, across gate regions (indicated by the circles in FIG. 3) and a channel stop region CS2. With another column of pixel sensors S, the vertical transfer portions 10 and 11 are adjacent to each other, and thus, a channel stop region CS1 is interposed therebetween to prevent the mixture of signals.

In this pixel structure, a vertical transfer electrode is formed of two layers, i.e., a first electrode D1 and a second electrode D2, which apply a common clock to the two vertical transfer portions 10 and 11. In the pixel sensors S, the reading direction of electric charges, i.e., to which vertical transfer portion 10 or 11 electric charges are read is determined by the position of the pixel sensors S. That is, electric charges are read to the vertical transfer portion 10 or 11 closer to the image sensor S (see the arrows in FIG. 3).

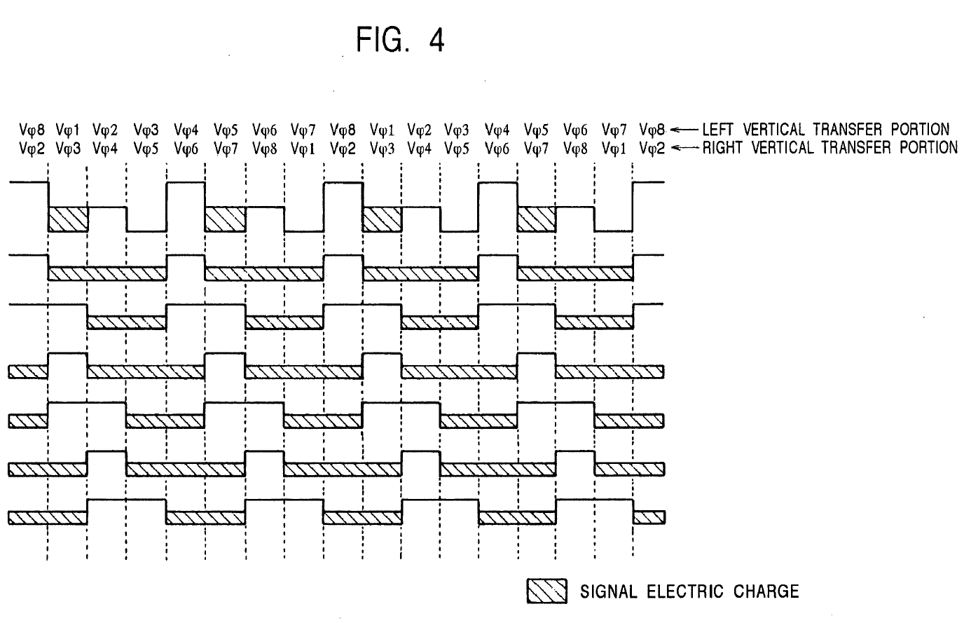

The normal imaging operation (driving method) of this solid-state imaging device is described below with reference to the potential diagram of FIG. 4. In this solid-state imaging device, eight-phase driving is performed by using eight vertical transfer clocks Vφ1 through Vφ8, assuming that a vertical addition function is used.

Since the reading clock is applied to Vφ1, Vφ3, Vφ5, and Vφ7, the potential can be indicated as shown in FIG. 4. FIG. 4 shows that the upper section of the vertical transfer clocks corresponds the left vertical transfer portions 10 and that the lower section of the vertical transfer clocks corresponds the right vertical transfer portions 11. The signal operation in this structure is discussed below with reference to the elements shown in FIG. 3. The electric charges in the pixel sensor S1-1 are read to the right vertical transfer portion 11, the electric charges in the pixel sensor S1-2 are read to the left vertical transfer portion 10, the electric charges in the pixel sensor S1-3 are read to the right vertical transfer portion 11, and the electric charges in the pixel sensor S1-4 are read to the left vertical transfer portion 10, as indicated by the arrows in FIG. 3.

The electric charges in the pixel sensor S2-1 are read to the right vertical transfer portion 10, the electric charges in the pixel sensor S2-2 are read to the left vertical transfer portion 11, the electric charges in the pixel sensor S2-3 are read to the right vertical transfer portion 10, and the electric charges in the pixel sensor S2-4 are read to the left vertical transfer portion 11, as indicated by the arrows in FIG. 3.

Accordingly, since, in each vertical transfer portion 10 or 11, a reading packet has empty packets before and after the reading packet, Vφ2 and Vφ6 are simultaneously set to be the H level when reading electric charges. As a result, the amount of electric charges handled in the vertical registers after reading can be sufficiently ensured.

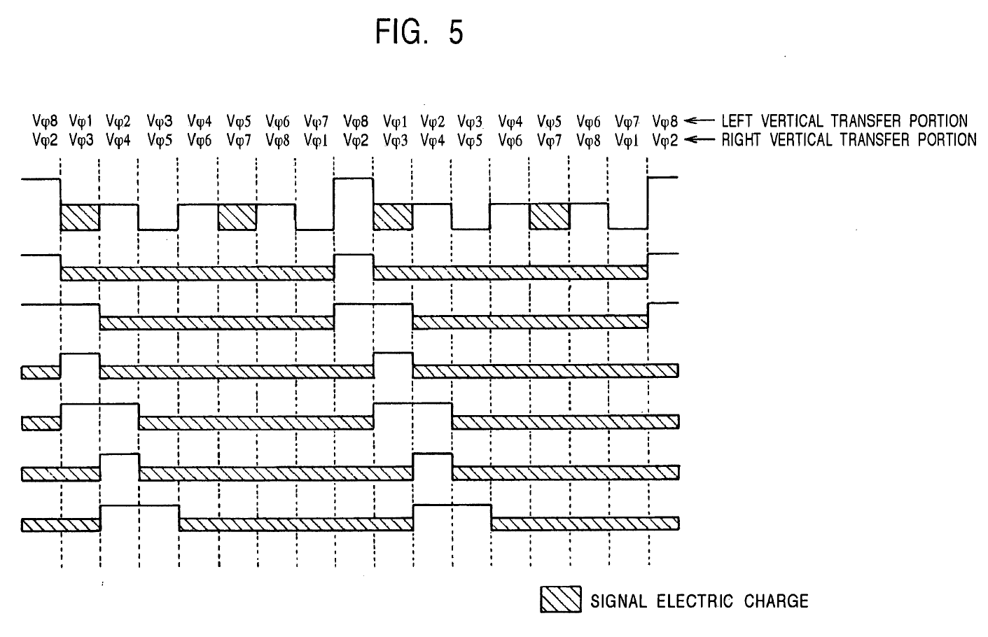

The operation for vertically adding electric charges (driving method) of this solid-state imaging device is discussed below with reference to the potential diagram of FIG. 5. As in the normal imaging operation, since the reading clock is applied to Vφ1, Vφ3, Vφ5, and Vφ7, the potential can be represented as indicated by FIG. 5. As in FIG. 4, in FIG. 5, the upper section of the vertical transfer clocks corresponds to the left vertical transfer portions 10, and the lower section of the vertical transfer clocks corresponds to the right vertical transfer portions 11. In this case, in addition to Vφ2 and Vφ6, Vφ4 is also set to be the H level, and then, electric charges for two pixels of the same color in the vertical direction can be added in the vertical transfer portion 10 or 11.

Accordingly, by the use of the structure of this embodiment, even in the progressive-scan-system solid-state imaging device, two pixels of the same color in the vertical direction can be added without a time difference, which cannot be achieved by the related art.

According to the structure of the present invention, the number of vertical transfer electrodes for one pixel can be reduced to two. Thus, in comparison with a known vertical four-phase progressive-scan system, with the same number of vertical transfer cycles, the time required for transferring the same amount of electric charge can be reduced to one half, thus implementing a fast transfer operation.

Although in this embodiment two pixels of the same color are added vertically, the number of pixels of the same color to be added may be other than two, for example, three pixels or four pixels of the same color may be added vertically by allowing the controller to control the timing.

1. A solid-state imaging device comprising:
sensor areas, in each of the sensor areas, a plurality of pixel sensors are disposed in the vertical direction and in the horizontal direction;
two vertical transfer portions formed across each pixel column including the plurality of pixel sensors in the vertical direction; and
control means for controlling electric charges stored in the pixel sensors vertically adjacent to each other in each pixel column to be simultaneously read in different directions by the two vertical transfer portions, and also for controlling each of the two vertical transfer portions to add and transfer electric charges for the plurality of pixel sensors.

2. The solid-state imaging device according to claim 1, wherein pixels stored in all the pixel sensors are simultaneously read to the corresponding vertical transfer portions.

3. The solid-state imaging device according to claim 1, wherein identical color filters are provided for every other pixel sensor in each pixel column.

4. A driving method for a solid-state imaging device which comprises sensor areas, in each of the sensor areas, a plurality of pixel sensors are disposed in the vertical direction and in the horizontal direction; two vertical transfer portions formed across each pixel column including the plurality of pixel sensors in the vertical direction; and control means for controlling electric charges stored in the pixel sensors to be read to the corresponding vertical transfer portions with a predetermined timing, said driving method comprising the step of controlling electric charges stored in the pixel sensors vertically adjacent to each other in each pixel column to be simultaneously read in different directions by the two vertical transfer portions, and also for controlling each of the two vertical transfer portions to add and transfer electric charges for the plurality of pixel sensors.

5. The driving method according to claim 4, wherein the control means controls pixels stored in all the pixel sensors to be simultaneously read to the corresponding vertical transfer portions.

6. An imaging apparatus for reading images by using a solid-state imaging device which comprises:
sensor areas, in each of the sensor areas, a plurality of pixel sensors are disposed in the vertical direction and in the horizontal direction;
two vertical transfer portions formed across each pixel column including the plurality of pixel sensors in the vertical direction; and
control means for controlling electric charges stored in the pixel sensors vertically adjacent to each other in each pixel column to be simultaneously read in different directions by the two vertical transfer portions, and also for controlling each of the two vertical transfer portions to add and transfer electric charges for the plurality of pixel sensors.
